(19) United States
(12) Patent Application Publication
(10) Pub. No.: US 2026/0093281 A1
(43) Pub. Date: Apr. 2, 2026

(54) PROGRAMMABLE VOLTAGE REGULATOR FEEDBACK CIRCUIT AND METHOD OF OPERATION

(71) Applicant: Arm Limited, Cambridge (GB)

(72) Inventors: Yimajian YAN, Santa Clara, CA (US); Rainer HERBERHOLZ, Great Abington (GB); Stuart James AITKEN, Cambridge (GB); James Robert WILLIAMSON, Dripping Springs, TX (US); Christopher T. WEAVER, Boxborough, MA (US); Sumant SRIKANT, Cambridge (GB)

(21) Appl. No.: 19/345,356

(22) Filed: Sep. 30, 2025

Related U.S. Application Data
(60) Provisional application No. 63/701,704, filed on Oct. 1, 2024.

(51) Int. Cl. G05F 1/575; G05F 1/565; G06F 1/3296

(52) U.S. Cl. CPC G05F 1/575; G05F 1/565; G06F 1/3296

(57) ABSTRACT

There is provided a voltage feedback circuit including: a programmable voltage feedback amendment circuit configured to take an input voltage from a supply rail and generate a feedback signal to a voltage regulator (VR) so causing an output voltage of the VR to be adjusted from a VR operating setpoint, wherein the adjustment from the VR operating setpoint is programmable by the feedback amendment circuit. In addition, there is provided a system including the voltage feedback circuit and a VR. Finally, there is provided a method of adjusting a voltage in a voltage feedback circuit, the method including: taking an input voltage from a supply rail at a feedback amendment circuit; and generating a feedback signal to a VR so causing an output voltage of the VR to be adjusted from a setpoint; wherein the adjustment from the setpoint is programmable by the feedback amendment circuit.

### CROSS-REFERENCE TO RELATED APPLICATIONS

The present application claims the benefit of U.S. Provisional Application No. 63/701,704, filed Oct. 1, 2024, entitled Programmable Voltage Regulator Feedback Circuit and Method of Operation, which is hereby incorporated by reference in its entirety.

### TECHNICAL FIELD

Present techniques relate generally to processor power management. More specifically, embodiments of present techniques use dynamic voltage and frequency scaling adjustment for power management and fast voltage scaling in an integrated device.

### BACKGROUND

Integrated circuit (IC) devices include processing components such as a central processing unit (CPU), a graphics processing unit (GPU) as well as processing components optimised for neural networks used in machine learning and artificial intelligence applications. Applications of these processing components are many and varied and include general purpose computing applications as well as use in smartphones, personal computer and mobile gaming, embedded systems, autonomous vehicles, data centres and high-performance computing. Depending on the deployed architecture and application, processors can vary greatly in terms of performance, power consumption and scalability.

Dynamic voltage and frequency scaling (DVFS) techniques are very effective in reducing power, since lowering the voltage has a squared effect on active power consumption. DVFS techniques provide ways to reduce power consumption of chips on the fly by scaling down the voltage and frequency based on the targeted performance requirements of the application. Since DVFS optimizes both the frequency and the voltage, it is highly effective on both dynamic and static power.

It has been noted that, with many applications, the performance required of the processor may vary relatively widely and frequently. Stated alternatively, the applications may utilize the processing power of the processor relatively fully for periods intermixed with periods in which the applications utilize the processing power relatively sparingly. The length of the periods between which the utilization changes significantly may be relatively short, such as on the order of microseconds. Thus, the finer the granularity at which a DVFS implementation can scale the voltage-frequency, the potentially larger the energy savings that may be realized. Otherwise, much potential energy savings is lost due to the coarseness of the granularity.

### SUMMARY

The present technology is directed to a method and electronic circuit for improving response times in systems having dynamic voltage and frequency scaling. Present techniques may be considered to provide a voltage regulator feedback line with two functions: namely, firstly to provide a feedback path for a ratio or relative voltage scaled with respect to an input voltage and secondly to steer the output voltage of the voltage regulator to an adjusted voltage with low latency in the order of microseconds.

As will be clear to one of skill in the art, a hybrid approach may also be taken, in which hardware logic, firmware and/or software may be used in any combination to implement the present technology.

According to a first aspect of present techniques there is provided a voltage feedback circuit comprising: a programmable voltage feedback amendment circuit configured to take an input voltage from a supply rail and generate a feedback signal to a voltage regulator so causing an output voltage of the voltage regulator to be adjusted from the voltage regulator operating setpoint, wherein the adjustment from the voltage regulator operating setpoint is programmable by the feedback amendment circuit.

In one aspect, the programmable voltage feedback amendment circuit is configured to generate the feedback signal to the voltage regulator in response to a signal request to generate an amended voltage applied to a load.

In one aspect, the feedback signal is a ratio voltage scaled with respect to the input voltage from the supply rail.

In one aspect, the voltage regulator adjusts the output voltage by increasing output current until the ratio voltage is equal to the voltage regulator operating setpoint.

In one aspect, the programmable voltage feedback amendment circuit is configured as a programmable voltage divider.

In one aspect, the signal request to generate an amended voltage is applied to the load is a digital signal and generated based on changes in operating parameters of the load.

In one aspect, the causing the output voltage of the voltage regulator to be adjusted is generated by a module configured to convert a target processor frequency request into a minimum voltage for the load.

In one aspect, the module is a look-up table in hardware or software comprising both frequency and equivalent voltage levels in storage.

In one aspect, the programmable voltage divider and a load are provided on-chip, wherein the voltage regulator is provided off-chip.

In one aspect, the voltage regulator operating setpoint corresponds to a minimum operational voltage or a retention voltage which is less than the minimum operational voltage.

In one aspect, the programmable voltage divider comprises a programmable resistive divider. In one aspect, wherein the resistive divider comprises switchable shunt resistors. In one aspect, the resistive divider has N resistors and is thermometer encoded and N+1 levels or binary weighted and the resistive divider has 2^{N} levels. In one aspect, located on-chip is a voltage to frequency translation module to track the input voltage from the supply rail and apply a change in frequency to a load according to a change in input voltage.

In one aspect, the voltage to frequency translation module comprises a frequency generator such as a digitally controlled oscillator, optionally a phase locked loop.

In one aspect, the voltage regulator operates within a closed loop feedback circuit to continually adjust the regulated output voltage based upon telemetry from the load.

In one aspect, the telemetry includes core frequency performance statistics and temperature measurements.

In one aspect, a temperature sensor is configured to monitor the thermal conditions of the load and provide telemetry with reference to a look-up table.

In one aspect, the circuit includes multiple loads coupled to the supply rail and a multiplexer configured to receive input voltages each corresponding to a voltage at a respective load of the multiple loads and multiplex input voltages depending upon which load is active such that an output of the multiplexer corresponds to a lowest of the input voltages to the multiplexer.

A further aspect of present techniques provides a system comprising: the circuit described here, implemented in at least one packaged chip; at least one system component; and a board, wherein the at least one packaged chip and the at least one system component are assembled on the board. In one aspect, the chip-containing product is assembled on a further board with at least one other product component.

A further aspect of present techniques includes a non-transitory computer-readable medium to store computer-readable code for fabrication of the circuit described herein.

A further aspect of present techniques includes a method of adjusting a voltage in a voltage feedback circuit comprising: taking an input voltage from a supply rail at a feedback amendment circuit; generating a feedback signal to a voltage regulator so causing the output voltage of the voltage regulator to be adjusted from the voltage regulator operating setpoint, wherein the adjustment from the voltage regulator operating setpoint is programmable by the feedback amendment circuit.

A further aspect of present techniques includes a non-transitory computer readable medium comprising a structure of data and imperatives operable to cause a device to construct a set of electronic logic components which, when embedded in an electronic device and activated thereon, cause the electronic device to perform the steps of the method described herein.

A further aspect of the present techniques includes a programmable voltage feedback circuit comprising: a programmable voltage divider configured to take an output voltage from a voltage regulator and, in response to a signal request to adjust the output voltage to new setpoint, the programmable voltage divider being configured generate a feedback voltage amendment signal to the voltage regulator so causing an output voltage of the voltage regulator to be adjusted from the voltage regulator operating setpoint to the new setpoint, wherein the adjustment from the voltage regulator operating setpoint is programmable by the programmable voltage divider.

In one aspect, the signal request is a digital signal and generated based on changes in operating parameters of the load. In one aspect, the adjustment provides that a voltage adjustment approaches a target voltage within a tolerance limit, optionally reaches or matches the target voltage, steps towards the target voltage or goes beyond the target voltage within predetermined tolerances.

A further aspect of present techniques includes a method of regulating a voltage output comprising: setting a voltage regulator with a set input voltage; sensing an operating voltage output from the voltage regulator; receiving a signal that the operating voltage should be adjusted to a target voltage; in response to the signal, reducing the sensed operating voltage by a ratio and communicating a sensed voltage amendment signal to the voltage regulator; wherein the voltage regulator compares the sensed voltage amendment signal to the set input voltage and generates an adjustment to the operating voltage output, wherein the adjustment provides that the operating voltage output substantially matches the target voltage. In one aspect, the voltage feedback circuit comprises a DAC.

A further aspect of present techniques includes a system comprising: the voltage feedback circuit of any previous aspect; and a voltage regulator configured to receive a set input voltage for a load and configured to output the set input voltage to the load as a regulated output voltage; wherein the programmable voltage feedback amendment circuit is coupled to an output of the voltage regulator to sense the regulated output voltage and, in response to a signal request to adjust the regulated output voltage to a target voltage, the programmable voltage feedback amendment circuit is configured to reduce the sensed regulated output voltage by a ratio to generate the feedback signal applied to the voltage regulator; wherein the voltage regulator is configured to compare the feedback signal to the set input voltage to generate an adjustment to the regulated output voltage.

In one aspect, the adjustment provides that the regulated output voltage to the load substantially matches the target voltage. In one aspect, the signal to request to adjust the regulated output voltage is a digital signal and generated based on changes in operating parameters of the load. In one aspect, the digital signal is digital representation of the target voltage. In one aspect, the target voltage is generated by a module configured to convert a target processor frequency request into a minimum voltage for the load. In one aspect, the module is a look-up table in hardware or software comprising both frequency and equivalent voltage levels in storage. In one aspect, the programmable voltage divider and load are provided on-chip, wherein the voltage regulator is provided off-chip. In one aspect, the set voltage corresponds to a minimum operational voltage or a retention voltage which is less that the minimum operational voltage. In one aspect, the programmable voltage divider comprises an adjustable resistive divider. In one aspect, located on-chip is a voltage to frequency translation module to track the regulated output voltage and apply a frequency according to a change in the target voltage. In one aspect, the voltage to frequency translation module comprises a frequency generator such as a digitally controlled oscillator, optionally a phase locked loop. In one aspect, the voltage regulator operates within a closed loop feedback circuit to continually adjust the regulated output voltage based upon telemetry from the load. In one aspect, the telemetry includes core frequency performance statistics and temperature measurements. In one aspect, a temperature sensor is configured to monitor the thermal conditions of the load and provide telemetry. In one aspect, the adjustment provides that the regulated output voltage to the load substantially matches the target voltage includes approaches the target voltage within a tolerance limit, reaches the target voltage or steps towards or beyond the target voltage within predetermined tolerances. In one aspect, the circuit includes multiple loads coupled to the supply rail and a multiplexer configured to receive input voltages each corresponding to a voltage at a respective load of the multiple loads and multiplex input voltages depending upon which load is active such that an output of the multiplexer corresponds to a lowest of the input voltages to the multiplexer.

### BRIEF DESCRIPTION OF THE DRAWINGS

Implementations of the disclosed technology will now be described, by way of example only, with reference to the accompanying drawings, in which:

FIG. 1 shows a state of the art Dynamic Voltage and Frequency Scaling system architecture;

FIG. 2 shows one example of system architecture used to implement a Dynamic Voltage and Frequency Scaling method according to an implementation of the present technology;

FIG. 3 shows one example of a programmable voltage divider according to an implementation of the present technology;

FIG. 4 illustrates a system and a chip-containing product;

FIG. 5 shows one example of a multiplexer according to an implementation of the present technology; and

FIG. 6 illustrates a method of adjusting a voltage in a voltage feedback circuit according to an implementation of the present technology.

### DETAILED DESCRIPTION

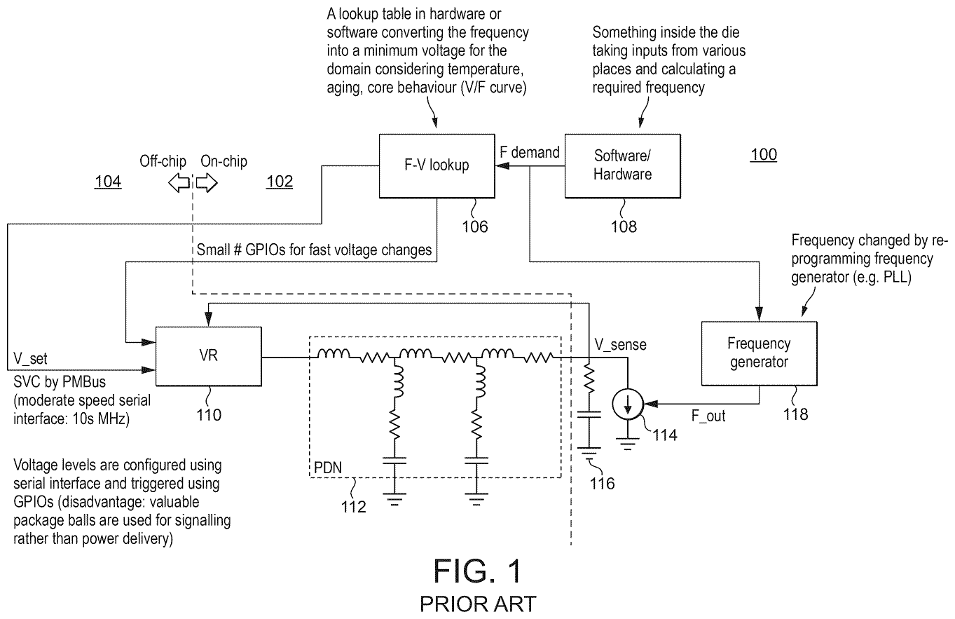

Therefore, as described herein with reference to FIGS. 1 to 5, the present techniques generally relate to the provision of a programmable voltage divider in a feedback path of a voltage regulator to cause the voltage regulator to adjust its output voltage. The programmable voltage divider is, in one aspect, provided as part of an integrated circuit with the programmable voltage divider and one or more cores being fabricated on the same die or on a single semiconductor substrate. Here the one or more cores include a load such as a central processing unit, graphics processing unit or machine learning, neural network configured processor, for example.

Accordingly, the overall system provides a device and method of changing Dynamic Voltage and Frequency Scaling (DVFS) points without additional connections between the silicon on chip and voltage regulator. This advantage results because the coupling between the programmable voltage divider and voltage regulator is made between a standard input terminal of the voltage regulator and an output terminal of the programmable voltage divider.

Therefore, according to present techniques the programmable voltage divider has an output trace connected to an input terminal of the voltage divider. The output trace of the programmable voltage divider carries a feedback signal, such as an amended sense voltage [referred to as V_sense_amend] adjusted relative to an input voltage.

Present techniques may be considered to provide a voltage regulator feedback line with two functions: namely, firstly to provide a feedback path for the voltage regulator and secondly to steer the output voltage of the voltage regulator by feeding back a ratio or scaled version of the voltage regulator's output voltage.

Present techniques provide a feedback control system where a programmable voltage divider is used to adjust the output of a voltage regulator by reducing the sensed output voltage to a proportional, relative or ratio value to create a feedback signal. The system comprises a load such as a processor that requires a regulated voltage and a voltage regulator that is programmed with a predetermined set voltage which is typically a minimum required voltage that is required by the load. By reducing the sensed output voltage to a ratio applied to the voltage regulator, the programmable voltage divider could be said to be forcing the voltage regulator to increase its output voltage to bring the output voltage closer to a target voltage.

In use, the programmable voltage divider continually feeds a proportionally reduced voltage back to the voltage regulator as part of the feedback loop. As the voltage regulator adjusts its output, the feedback pushes the voltage regulator to continually make adjustments to match the target voltage.

In a dynamic voltage and frequency scaling system, the software or hardware typically makes a request to amend from a first voltage and frequency state to a second voltage and frequency state which may comprise increasing voltage or frequency. Alternatively, the transition from a first voltage and frequency state to a second voltage and frequency state may comprise decreasing voltage or frequency.

Initiating the transition may comprise initiating the transition responsive to a signal from software, such as an operating system or software.

Accordingly, the software or hardware will make a clock frequency request and the frequency to voltage values are converted to a voltage demand. Then the voltage demand selects the reduction level of the voltage regulator sensed voltage. When the voltage regulator control sees the sensed voltage drop, it will increase the output current until the sensed voltage is again raised by the same amount it is reduced from the sense point. Then the voltage to frequency values enable a higher frequency.

In embodiments according to the description or as illustrated in figures, modules or sections labelled or described as being operated in software may be provided in hardware and vice versa.

The system architecture domain includes many components including one or more cores, interconnects, storage, clocks and so on. In operation, on-chip or off-chip telemetry is constantly taking inputs from various sources with the domain and these inputs are fed into a software module to make decisions on whether an adjusted clock frequency is required for the domain. The input to a software module then decides a new frequency is required based on the telemetry and a look-up table in hardware or software is operable to convert that new frequency into a new, adjusted voltage for the domain taking account of factors such as temperature, aging, voltage/frequency behaviour of the core. The look-up table is a F-V table with frequency values matched to appropriate operating voltages.

Then output of the look-up table is a digital representation of the new, target or adjusted voltage and can be referred to as a digital signal, V_demand. The digital signal V_demand is used to control a programmable voltage divider operating in embodiments as a Digital to Analog converter (DAC). As one example, the programmable voltage divider implements a resistive divider.

In embodiments, if all switches are off in the programmable voltage divider, then the programmable voltage divider is in essence by passed and so any output voltage from the voltage regulator (V_sense) is applied to a load of the circuit (eg a core) without any attenuation. In embodiments, the output of the voltage regulator is coupled to the load. Any attenuation is on the feedback path back to the voltage regulator. So, if all switches are off there is no attenuation of a voltage, but in an alternative embodiment, one or more of the switches of the programmable voltage divider can be switched-on and cause attenuation of the voltage. The attenuation in embodiments could be binary weighted or thermometer weighted, for example.

Whilst the programmable voltage divider can be in circumstances considered as a DAC, this is not essential to present techniques because the programmable voltage divider can be configured in many arrangements. The configuration can comprise any number of transistors depending on the resolution required and the number of different voltage steps required for generation and any coding used for the resistor values that can turned on for each of these transistors.

In the example of an attenuated voltage, V_sense_amend is less than or equal to V_sense and V_sense_amend is a signal fed back to the voltage regulator.

A conventional state of the art voltage regulator like a switch-mode voltage regulator uses analog control methods such as feedback loops to compare the feedback signal V_sense_amend to a set point that is also programmable in a traditional way. The set point can be programmed over many options such as an interface Power Management Bus, PMBus and the set point is typically equal to the lowest possible voltage that the domain requires under any predetermined operating circumstances.

An output of the Voltage Regulator is applied to a Power Delivery Network, which in embodiments can be on a board, a package and a die. An output of the Power Delivery Network comprises some on die decoupling and a coupling to the load of the core (represented by some kind of circuitry) or put more generally any device that needs to be modulated in terms of its power vs frequency curve. In embodiments, the load is represented by a current source and is highly variable. As such, the load is not a constant current source. An output of the power delivery network is core supply voltage.

On die with the programmable voltage divider, is a voltage to frequency translation module (V-F translation). The V-F translation module is enabled to translate an appropriate operating frequency from the core supply voltage. Many configurations are possible such as a frequency lock loop that tracks the core supply voltage or one or more voltage tracking frequency generators. A voltage to frequency look-up table can also be used. VF translation is broader than V-F lookup because VF translation includes frequency locked loops. Its role is to control the clock, independently of how the change in voltage is communicated. There is a clock source that always dials in the maximum clock frequency supportable with the present voltage.

In embodiments, the system architecture is designed so that the frequency settings follow the voltage settings. Instead of specifying and controlling both separately, the voltage is set and the frequency is designed to follow the voltage changes. Therefore, present techniques adjust the frequency to the maximum that is allowed with respect to that operating voltage.

Consider the following use case: Operating parameters demand 2 GHZ, but the sensed voltage V_sense is too low to allow the circuit to operate with 2 GHz. The software would see from telemetry the actual workload process from the core and so it would increase its frequency demand by first initiating a higher voltage demand so that the increase in frequency follows the increase in voltage. It is also provided in embodiments that there is a mechanism by which the frequency demand is not met if there is a thermal limit present, for example.

In operation, it can be considered that in a pass-through mode, the programmable voltage divider is off. In pass-through mode, the input voltage V_demand equal to the output voltage V_sense. So, we enable the voltage regulator at the minimum voltage V_set that we want and has been set. There are a few options for this minimum voltage V_set which could be the minimum operational voltage or a retention voltage which is less that the operational voltage, for example.

In an adjustment mode, the domain requires as an example an increase in the frequency, which requires a higher voltage. In turn, some of the switches of the programmable voltage divider are switched on so that the V_sense_amend signal drops to be lower than V_sense signal so that the ratio of the two signals V_sense and V_sense_amend is less than unity. This ratio value can be considered as an attenuation factor. V_sense_amend signal is coupled to the voltage regulator which in turn increases its output voltage until the amended sense voltage V_sense_amend is equal to the set voltage V_set so it is back in regulation.

When it is back in regulation the output voltage of the regulator which we are calling V_sense is equal to the set voltage V_set divided by the attenuation factor which is a number no bigger than unity so we get a higher output voltage and we can repeat as necessary to go up or down in voltage, just by changing the attenuation factor. The attenuation factor varies and is set by changing the digital controls that go to the programmable voltage divider input word so change very fast, for example as often as a few microseconds. As such, present techniques intentionally generate an offset in the voltage that is fed back to the voltage regulator to force the voltage regulator's control loop to dial in a different output voltage.

Accordingly, in embodiments V_sense_amend remains proportional in output to V_demand as a digital code word to be applied to a voltage divide ratio module or programmable voltage divider. In embodiments, as described herein the programmable voltage divider can be considered to operate as a Digital to Analog Converter (DAC) when it is used to convert a digital signal into an analog output signal.

Present techniques avoid a prior art requirement of controlling a voltage regulator by manipulating V_set over a shared control bus and so enables our fast updates. We avoid the latency of that shared control bus and do not require an additional voltage rail control bus that needs many signals. A prior art approach may take programmable general purpose IOs in the voltage regulator which are pre-programmed so when switched those GPIOs can program a response by the voltage regulator with the GPIOs sitting between the Silicon on chip and the voltage regulator. An extra wire is required for retention voltage to a GPIO in addition to the set voltage. If a design requires to code more responses, then the system requires more GPIOs or a serial bus and send a digital code word coded and clocked. The prior art approach uses valuable chip real estate for signalling and results in a lack of area for connectivity for power delivery as much of the area is taken up by the signalling. One advantage of present techniques is that package balls that might have been used for signalling between the SoC and voltage regulator (GPIOs, serial bus etc.) are now available for delivering power.

In the alternative, present techniques force the voltage regulator to a new set point by manipulating its analogue feedback to provide an extremely agile solution where we can change the voltage and frequency on a micro second basis removing the prior art need to communicate that change over some digital bus serial interface, for example.

The adjustment to the new set point provides that the output voltage of the voltage divider to the load substantially matches the new set point. In practice, this may mean that the output voltage is changes so it approaches the new set point within an acceptable tolerance limit, it reaches the setpoint and may also overshoot the setpoint but within acceptable tolerance limits of circuit conditions. A tolerance limit may be set in Volts depending on the resolution of the change required.

In embodiments, V_set is not changed dynamically. For example, if the lowest voltage is 0.5V then the voltage regulator always operates as if it is producing 0.5V but actually it is not, we give the voltage regulator the impression that it does produce 0.5V through the programmable voltage divider to meet the system requirements.

As a use case example, when V_set is 0.5V and V_sense is 0.5V, a signal is generated based on telemetry requiring a new power voltage, V_demand of 0.6V then we need to generate 0.1V (100 millivolts). The difference between the V_sense and the V_demand is 0.1V. That means when V_sense is 600 mv we subtract 100 mv and the voltage regulator, operating as it has set point voltage of 500 mV, does not regulate to 500 mV, but instead the actual output voltage is 600 mV.

In an additional embodiment, a multiplexer can be connected to the output of the power delivery network and to the programmable voltage divider to measure V_sense. Different sense points can be coupled and then muxed between them. So, taking multiple points then using a mux and then take output of one. For example, consider an example where a rail is shared between a CPU and a neural processor and in one operating domain, the system only operates on one of the core or the neural processor because of power budget considerations. In this case, we sense into both processors and then MUX. So, the voltage regulator is then for both processors.

Processors may share a voltage regulator using a MUX, for example a CPU, neural processor or GPU can be on the same die. The programmable voltage divider is also shared. Accordingly, the load is the CPU, GPU or whatever that is being regulated and we have multiple loads to be regulated and v_sense is multiplexed.

Referring to FIG. 1, a state of the art Dynamic Voltage and Frequency Scaling system architecture 100 comprises an on-chip section 102 and an off-chip section 104. On chip 102 section includes a frequency-voltage look-up table 106 in hardware or software for converting a frequency demand signal generated by a component or components 108 located on-chip 102. The component or components 108 take telemetry inputs from various locations and calculate a required frequency. The frequency-voltage look-up table 106 converts the required frequency into a minimum voltage for the domain considering factors such as temperature, aging and core behaviour based on a V/F. A look-up table may be the following form as an example, as illustrated in TABLE 1 below:

TABLE 1

| Maximum Clock Frequency | Supply Voltage | |
|---|---|---|
| 300 MHz | 1 | V |
| 600 MHz | 1.2 | V |

| | |
|---|---|
| 800 MHz | 1.3 |

The frequency-voltage look-up table 106 has an output terminal coupled to an input terminal (or multiple input terminals) of an off-chip 104 voltage regulator using a number of GPIOs for voltage change. Additionally, the voltage regulator 110 comprises input terminal to receive from the frequency-voltage look-up table 106 a set voltage, V_set, SVC by PMBus eg. a moderate speed serial interface) working perhaps at 10s MHz.

Voltage levels are configured using the serial interface and triggered using GPIOs which results in a disadvantage that valuable package balls are used for signalling rather than for power delivery.

The voltage regulator 110 has an output terminal coupled for a power delivery network 112 having an output terminal coupled of a load 114 (eg. a processor core, shown as a current source and an on-die coupling 116. A voltage v_sense is taken off the die and coupled back to the voltage regulator 110 so that the voltage regulator can adjust its output voltage based on a comparison of a voltage required based on a frequency requirement from frequency-voltage look-up table 106, V_set and V_sense. Frequency generator 118 causes a change in clock frequency of the load 114 based upon the required frequency and is so coupled between the frequency-voltage look-up table 106 and component or components 108 located on chip 102 at one end and at another end to the load 114. The frequency is changed by re-programming a frequency generator such as a phase locked loop.

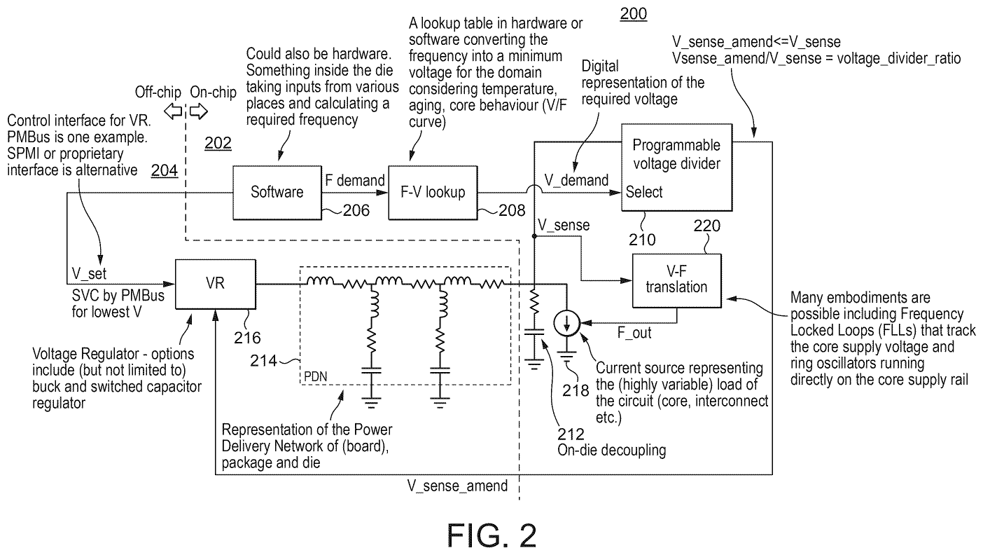

Referring to FIG. 2, one example of system architecture 200 used to implement a Dynamic Voltage and Frequency Scaling method according to an implementation of the present technology comprises on-chip 202 and off-chip 204 components.

On-chip 202 components include a software module 206 which can also be implemented in hardware to take inputs from various places and calculate a required frequency. A frequency to voltage look-up table module 208 provided in hardware or software for converting a required frequency into a minimum voltage for the domain considering factors such as temperature, aging and core behaviour. A programmable voltage divider 210 having a digital interface with the frequency to voltage look-up table module 208 to receive a digital representation of a required voltage. The programmable voltage divider 210 comprises an output to an on-die coupling 212 connected to an off-chip 204 power delivery network 214, coupled to a voltage regulator 216. On-chip 202 load 218 is coupled to the off-chip 204 power delivery network 214.

V-F translation module 220 is coupled to the load 218 and receives a sensed regulated voltage V_sense from the on-die coupling 212 line.

A feedback line is coupled from an output of the programmable voltage divider 210 to an input terminal of the voltage regulator 216. V_set (or a representation of this voltage) is internally generated in the voltage regulator 216 based on the information received from the SoC which is through an interface (e.g. PMBus).

In operation, in a first mode the voltage regulator 216 is off. In this case, the programmable voltage divider 210 is in passthrough mode (all the NMOS switches are off) and the voltage_divider_ratio=1 because voltage_divider_ratio=V_sense_amend/V_sense.

In a second mode the voltage regulator 216 is enabled at minimum set voltage. This could be minimum operational voltage or retention voltage less than the operational voltage.

$$Vsense\_amend = Vsense = Vset$$

In the second mode the voltage regulation and control loop work without adjustment to keep the voltage at the minimum set voltage.

In a third mode, a higher frequency and therefore higher voltage is required:

Therefore, some of the NFET switches are enabled in the programmable voltage divider.

In this third mode, Vsense_amend is less than Vsense to give a voltage divider ratio of less than unity i.e (voltage_divider_ratio<1)

And so V_sense_amend is equal to the voltage_divider_ratio multiplied by V_sense.

V_sense_amend is a ratio voltage and is applied as a feedback signal to the voltage regulator.

The voltage regulator 216 increases output voltage (Vsense) until Vsense_amend=Vset.

When back in regulation, Vsense=Vset/voltage_divider_ratio

Process repeats itself: core directs output voltage to increase or decrease by changing voltage_divider_ratio.

Dividing the feedback voltage does not change the ability of the voltage regulator 216 to respond to DC (IR drop) or AC transients (di/dt events)

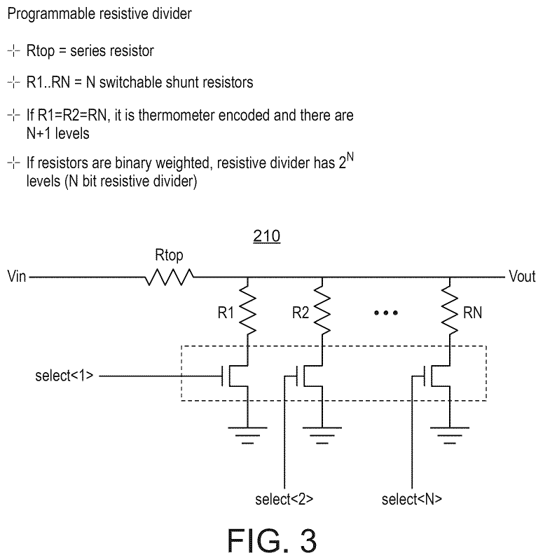

Referring to FIG. 3, one example of a programmable voltage divider according to an implementation of the present technology comprises the programmable voltage divider 210 shown a part of the system architecture in FIG. 2. Select lines can switch on or more transistors on or off according to the resolution required and value of attenuation.

In embodiments, Rtop is a series resistor and resistors R1, R2 to RN are switchable shunt resistors. If R1=R2=Rn then the programmable resistive divider is thermometer encoded and there are N+1 levels. Thermometer encoding is a method of digital encoding used to represent values in a unary format, where each value is represented by a sequence of binary ones followed by zeros eg. a 3-bit thermometer code is:
0 represented as 000
1 as 100
2 as 110
3 as 111.

Using thermometer encoding in this way on a programmable voltage divider can incrementally control the switches and resistors in the divider with one bit changes between adjacent values, providing smooth adjustments in voltage.

Binary weighted can be used to control voltage levels by controlling switches and resistors based on binary values. Eg:
0 represented as 00
1 as 001
2 as 010
3 as 011

Each bit contributes a fraction of total voltage output, with the most significant bit contributing the largest change and the least significant bit contributing the smallest. Binary weighted is efficient for large ranges of voltage control.

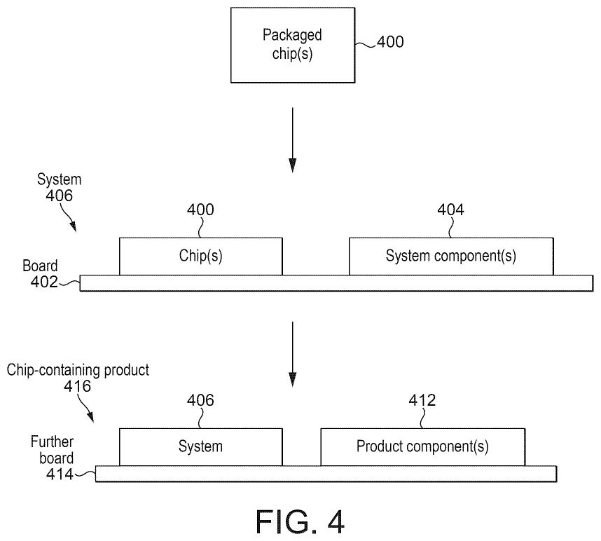

As shown in FIG. 4, one or more packaged chips 400, with the circuitry described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the circuitry described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

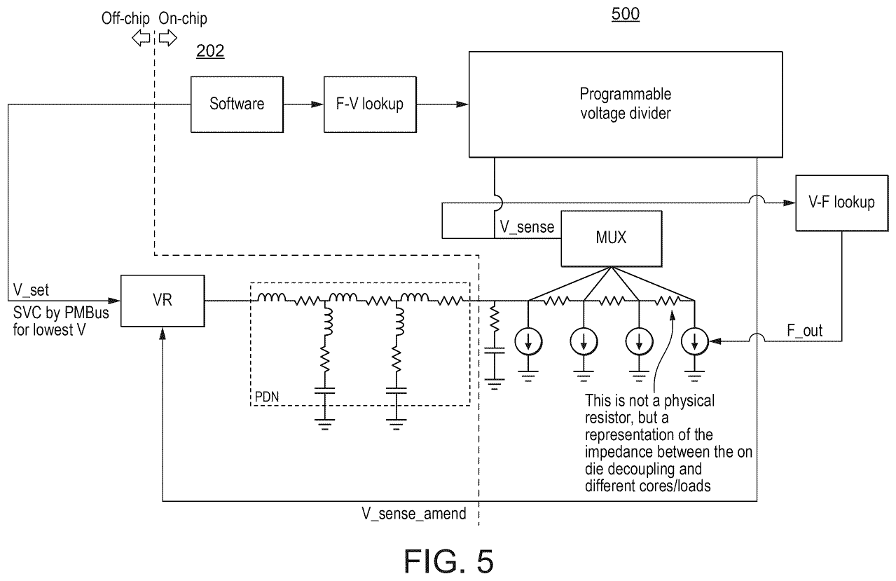

Referring to FIG. 5, one example of a multiplexer 500 according to an implementation of the present technology comprises multiplexer 500 embedded on-chip 202 according to the system architecture 200 as illustrated in FIG. 2. Multiplexer is coupled to an array of cores or loads and is configured to multiplex the sense point depending upon which load (core) is active.

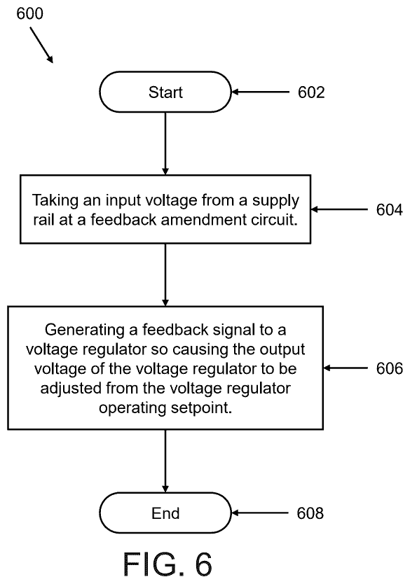

Referring to FIG. 6, there is illustrated a method 600 of adjusting a voltage in a voltage feedback circuit. The method 600 begins at Start 602. The method 600 comprises, at step 604, taking an input voltage from a supply rail at a feedback amendment circuit. Further, at step 606, the method 600 comprises generating a feedback signal to a voltage regulator so causing the output voltage of the voltage regulator to be adjusted from the voltage regulator operating setpoint. The adjustment from the voltage regulator operating setpoint caused by the generated feedback signal at step 606 may be programmable by the feedback amendment circuit. Finally, at End 608, the method 600 is finished.

As will be appreciated by one skilled in the art, the present technology may be embodied as a method, a circuit or a computer readable medium comprising data and imperatives to cause construction of a circuit. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A voltage feedback circuit comprising:
a programmable voltage feedback amendment circuit configured to take an input voltage from a supply rail and generate a feedback signal to a voltage regulator so causing an output voltage of the voltage regulator to be adjusted from a voltage regulator operating setpoint,
wherein the adjustment from the voltage regulator operating setpoint is programmable by the feedback amendment circuit.

2. The circuit of claim 1, wherein the feedback signal is a ratio voltage scaled with respect to the input voltage from the supply rail.

3. The circuit of claim 2, wherein the voltage regulator adjusts the output voltage by increasing output current until the ratio voltage is equal to the voltage regulator operating setpoint.

4. The circuit of claim 1, wherein the programmable voltage feedback amendment circuit is configured as a programmable voltage divider; and optionally wherein the programmable voltage divider and a load are provided on-chip, wherein the voltage regulator is provided off-chip.

5. The circuit of claim 4, wherein the programmable voltage divider comprises a programmable resistive divider; and optionally wherein the programmable resistive divider comprises switchable shunt resistors.

6. The circuit of claim 5, wherein the programmable resistive divider has N resistors, is thermometer encoded and has N+1 levels; or
wherein the programmable resistive divider has N resistors, is binary weighted and has 2N levels.

7. The circuit of claim 1, wherein the programmable voltage feedback amendment circuit is configured to generate the feedback signal to the voltage regulator in response to a signal request to generate an amended voltage applied to a load.

8. The circuit of claim 7, wherein the signal request to generate an amended voltage applied to the load is a digital signal and generated based on changes in operating parameters of the load.

9. The circuit of claim 1, wherein the causing the output voltage of the voltage regulator to be adjusted is generated by a module configured to convert a target processor frequency request into a minimum voltage for the load.

10. The circuit of claim 1, wherein the voltage regulator operating setpoint corresponds to a minimum operational voltage or to a retention voltage which is less than the minimum operational voltage.

11. The circuit of claim 1, including on-chip a voltage to frequency translation module to track the input voltage from the supply rail and apply a change in frequency to a load according to a change in input voltage.

12. The circuit of claim 1, wherein the voltage regulator operates within a closed loop feedback circuit to continually adjust the regulated output voltage based upon telemetry from the load.

13. The circuit of claim 12, wherein a temperature sensor is configured to monitor the thermal conditions of the load and provide telemetry, optionally with reference to a look-up table.

14. The circuit of claim 1, including multiple loads coupled to the supply rail and a multiplexer configured to receive input voltages each corresponding to a voltage at a respective load of the multiple loads and multiplex input voltages depending upon which load is active such that an output of the multiplexer corresponds to a lowest of the input voltages to the multiplexer.

15. A system comprising:
the circuit of claim 1, implemented in at least one packaged chip;
at least one system component; and
a board,
wherein the at least one packaged chip and the at least one system component are assembled on the board.

16. A chip-containing product comprising the system of claim 15 assembled on a further board with at least one other product component.

17. A non-transitory computer-readable medium to store computer-readable code for fabrication of the circuit of claim 1.

18. A method of adjusting a voltage in a voltage feedback circuit, the method comprising:
taking an input voltage from a supply rail at a feedback amendment circuit; and
generating a feedback signal to a voltage regulator so causing an output voltage of the voltage regulator to be adjusted from a voltage regulator operating setpoint;
wherein the adjustment from the voltage regulator operating setpoint is programmable by the feedback amendment circuit.

19. A non-transitory computer readable medium comprising a structure of data and imperatives operable to cause a device to construct a set of electronic logic components which, when embedded in an electronic device and activated thereon, cause the electronic device to perform the steps of the method of claim 18.

20. A system comprising:
the voltage feedback circuit of claim 1; and
a voltage regulator configured to receive a set input voltage for a load and configured to output the set input voltage to the load as a regulated output voltage;
wherein the programmable voltage feedback amendment circuit is coupled to an output of the voltage regulator to sense the regulated output voltage and, in response to a signal request to adjust the regulated output voltage to a target voltage, the programmable voltage feedback amendment circuit is configured to reduce the sensed regulated output voltage by a ratio to generate the feedback signal applied to the voltage regulator;
wherein the voltage regulator is configured to compare the feedback signal to the set input voltage to generate an adjustment to the regulated output voltage.
